(19) United States
(12) Patent Application Publication
(10) Pub. No.: US 2024/0184454 A1
(43) Pub. Date: Jun. 6, 2024

(54) STORAGE DEVICE AND OPERATING METHOD OF THE SAME

(71) Applicant: SK hynix Inc., Gyeonggi-do (KR)

(72) Inventor: Gi Pyo UM, Gyeonggi-do (KR)

(21) Appl. No.: 18/327,892

(22) Filed: Jun. 2, 2023

(30) Foreign Application Priority Data
Dec. 5, 2022 (KR) 10-2022-0167743

(51) Int. Cl. G06F 3/06; G06F 11/10

(52) U.S. Cl. CPC G06F 3/0619; G06F 3/0653; G06F 3/0679; G06F 11/1004

(57) ABSTRACT

A storage device includes a nonvolatile memory for storing data; a volatile memory including a plurality of banks; a plurality of detection engines, each detection engine acquiring a detection value representing validity of data stored in a corresponding bank among the plurality of banks; and a nonvolatile memory controller for determining, when a write request for requesting a write operation of storing data stored in a selected bank among the plurality of banks into the nonvolatile memory and a first detection value of the selected bank are received, whether the write operation is to be performed, based on the first detection value and a second detection value acquired by a detection engine corresponding to the selected bank after the write request is received.

### CROSS-REFERENCE TO RELATED APPLICATION

The present application claims priority under 35 U.S.C. § 119(a) to Korean Patent Application No. 10-2022-0167743 filed on Dec. 5, 2022, the entire disclosure of which is incorporated by reference herein.

### BACKGROUND

### 1. Field of Invention

Embodiments of the present disclosure generally relate to an electronic device, and more particularly, to a storage device and an operating method of the same.

### 2. Description of Related Art

A storage device may include a volatile memory and a nonvolatile memory. The volatile memory may retain stored data while power is supplied, and the nonvolatile memory may continuously retain data (i.e., information) stored therein even after power is not supplied.

The storage device may store, in the nonvolatile memory, data stored in the volatile memory to preserve the data stored in the volatile memory. A bit flip may occur in the volatile memory. The bit flip means that a value of stored data is changed by an error according to various physical factors or various software factors. That is, the data stored in the volatile memory is damaged, unlike an original state. For example, when the damaged data is information indicating a residual lifetime of the nonvolatile memory, it may be identified that the residual lifetime of the nonvolatile memory does not remain, unlike an actual state, and therefore, the nonvolatile memory may not be used any more, which is a critical issue. In order to prevent the damaged data from being stored in the nonvolatile memory, a validity check of data stored in the volatile memory is required. In addition, the validity check of data may result in performance deterioration of the storage device, and hence a plan for improving the efficiency of the validity check of data is required.

### SUMMARY

Various embodiments of the present disclosure is directed to provide a storage device capable of performing a validity check and an operating method of the storage device.

In accordance with an aspect of the present disclosure, there is provided a storage device including: a nonvolatile memory configured to store data; a volatile memory including a plurality of banks; a plurality of detection engines each configured to acquire a detection value representing validity of data stored in a corresponding bank among the plurality of banks; and a nonvolatile memory controller configured to determine, when a write request for requesting a write operation of storing data stored in a selected bank among the plurality of banks into the nonvolatile memory and a first detection value of the selected bank are received, whether the write operation is to be performed, based on the first detection value and a second detection value acquired by a detection engine corresponding to the selected bank after the write request is received.

In accordance with an aspect of the present disclosure, there is provided a method of operating a storage device, the method including: acquiring a first detection value of a selected bank among a plurality of banks included in a volatile memory; acquiring a second detection value of the selected bank in response to a write request for requesting a write operation of storing, in a nonvolatile memory, data stored in the selected bank; and determining whether the write operation is to be performed, based on the first detection value and the second detection value.

In accordance with an aspect of the present disclosure, there is provided a storage device including: a nonvolatile memory configured to store data; and a memory controller including a volatile memory. The memory controller is configured to acquire a first detection value of a selected bank among a plurality of banks included in the volatile memory; acquire a second detection value of the selected bank in response to a write request for requesting a write operation of storing, in the nonvolatile memory, data stored in the selected bank; and determine whether the write operation is to be performed by comparing the first detection value and the second detection value.

### BRIEF DESCRIPTION OF THE DRAWINGS

Various embodiments of the present disclosure will now be described more fully hereinafter with reference to the accompanying drawings; however, the embodiments may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a storage device in accordance with an embodiment of the present disclosure.

FIG. 2 is a detailed diagram of a volatile memory, an error detection engine, and a nonvolatile memory controller of the storage device in accordance with an embodiment of the present disclosure.

FIG. 3 is a diagram for describing an operation of a processor of the storage device in accordance with an embodiment of the present disclosure.

FIG. 4 is a flowchart for describing an operation of the storage device in accordance with an embodiment of the present disclosure.

FIG. 5 is a flowchart for describing detailed operations of the storage device in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

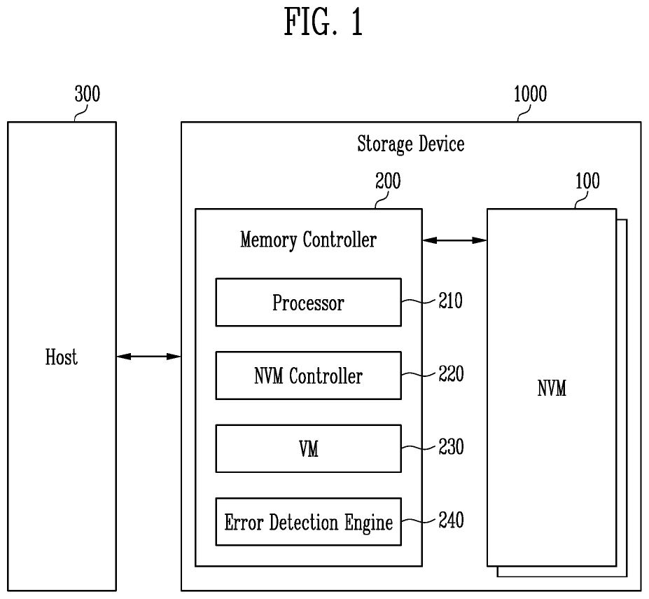

FIG. 1 is a diagram illustrating a storage device 1000 in accordance with an embodiment of the present disclosure.

Referring to FIG. 1, the storage device 1000 may store data according to a request of a host 300. The storage device 1000 may be one of various types of electronic devices including a multimedia card, a secure digital card, a Universal Serial Bus (USB) storage device, a Universal Flash Storage (UFS) device, a Peripheral Component Interconnect Express (PCI-e or PCIe) card type storage device, a Compact Flash (CF) card, a Network Attached Storage (NAS), a Direct Attached Storage, and the like. The host 300 may be one of various types of electronic devices including a mobile phone, a smart phone, an MP3 player, a laptop computer, a desktop computer, a game console, a TV, a tablet PC, an in-vehicle infotainment, and the like. The storage device 1000 may be mounted inside the host 300, or be implemented as an electronic device located at the outside of the host 300.

In an embodiment, the storage device 1000 may include a nonvolatile memory (NVM) 100 and a memory controller 200.

The memory controller 200 may control operations of the NVM 100. The NVM 100 may store data or output stored data under the control of the memory controller 200. For example, the memory controller 200 may transmit, to the NVM 100, a request (or command) for controlling the NVM 100 to perform a specific operation and an address representing (or designating) a storage area. Further, the memory controller 200 may transmit data to be stored to the NVM 100. For example, when the memory controller 200 transmits a write request, an address, and data to the NVM 100, the NVM 100 may perform a write operation of storing the data in a storage area represented by the address in response to the write request.

The NVM 100 may store data. The NVM 100 may preserve stored data in a state in which the supply of power is interrupted. In an embodiment, the NVM 100 may include a NAND flash memory. Further, the NVM 100 may include at least one of various types of memory devices including a phase change memory (PCM), a magnetoresistive random access memory (MRAM), a ferroelectric random access memory (FRAM), and the like.

In an embodiment, the memory controller 200 may include a processor 210, a NVM controller 220, a volatile memory (VM) 230, and an error detection engine 240. For example, although a case where the VM 230 and the error detection engine 240 are included in the memory controller 200 is illustrated in FIG. 1, one of the VM 230 and the error detection engine 240 may be located at the outside of the memory controller 200.

The processor 210 may control overall operations of the memory controller 200. For example, the processor 210 may include a Central Processing Unit (CPU). Meanwhile, the processor 210 may include at least one core. The core may be an integrated circuit of an independent unit, which can perform a computing process.

The processor 210 may generate a write request for controlling the NVM 100 to perform a write operation, or may generate a read request for controlling the NVM 100 to perform a read operation, an address, and the like. When a predetermined event occurs, the processor 210 may generate a write request and the like. For example, the predetermined event may be an event that a request is received, an event that a reference time elapses, an event that the supply of power is interrupted, or the like. The processor 210 may transmit a write request and the like to the NVM controller 220.

The NVM controller 220 may control the NVM 100. For example, the NVM controller 220 may control the NVM 100 to perform a write operation. More specifically, when a write request and an address are received from the processor 210, the NVM controller 220 may transmit to the NVM 100, the write request, the address, and data corresponding to the write request among data stored in the VM 230.

The VM 230 may temporarily store data. In the VM 230, stored data may be lost in a state in which the supply of power is interrupted. The data stored in the VM 230 may be data generated or processed by the processor 210, be data received from the host 300, or be data received from the NVM 100. For example, the data may be meta-data, logical-physical address mapping data, user data, or the like.

The VM 230 may include a Static Random Access Memory (SRAM). Further, the VM 230 may include various types of memory devices including a Dynamic RAM (DRAM), and the like.

The error detection engine 240 may acquire a detection value representing validity of data stored in the VM 230. The error detection engine 240 may transmit the acquired detection value to the processor 210 or the NVM controller 220.

In accordance with an embodiment of the present disclosure, the VM may be divided into a plurality of banks, thereby acquiring detection values in units of banks. In addition, detection values acquired at a specific time may be compared, thereby detecting an error of data stored in the VM 230. Accordingly, a validity check on data can be efficiently performed.

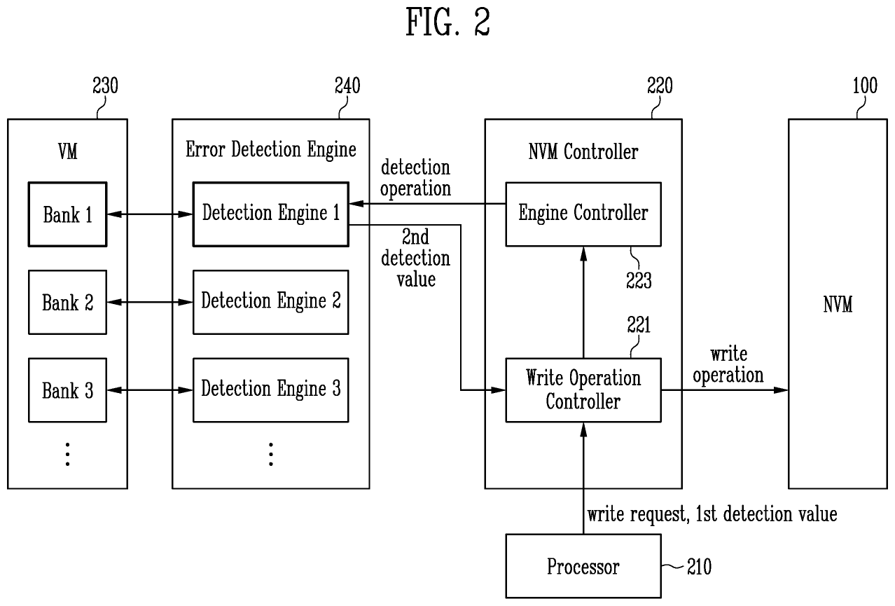

FIG. 2 is a detailed diagram of the VM 230, the error detection engine 240, and the NVM controller 220 of the storage device 1000 in accordance with an embodiment of the present disclosure.

Referring to FIG. 2, the VM 230 may include a plurality of banks BNK 1 to BNK3. A bank may be a storage area of a unit for storing data independently.

The error detection engine 240 may include a plurality of detection engines Detection Engine 1 to Detection Engine 3. A detection engine may correspond to one bank. For example, a first detection engine Detection Engine 1 may correspond to a first bank Bank 1, a second detection engine Detection Engine 2 may correspond to a second bank Bank 2, and a third detection engine Detection Engine 3 may correspond to a third bank Bank 3. In an embodiment, one detection engine may correspond to at least two banks. The detection engine may acquire detection value(s) of corresponding bank(s) by using data stored in the corresponding bank(s).

In an embodiment, the detection engine may acquire a detection value of a corresponding bank by using a checksum method. For example, when data stored in the first bank Bank 1 is configured with four bytes such as 0x25, 0x62, 0x3F, and 0x52, the first detection engine Detection Engine 1 connected to the first bank Bank 1 may acquire a first calculation value of 0x118 by summing all bytes. The first detection engine Detection Engine 1 may acquire a second calculation value of 0x18 by discarding a carry nybble in the first calculation value. The first detection engine Detection Engine 1 may acquire a third calculation value of 0xE8 by calculating a two's complement on the second calculation value. The third calculation value may be a detection value of the first bank Bank 1. Further, in an embodiment, a detection value representing validity of data may be acquired using one of various validity check methods including a parity check method, a Cyclic Redundancy Check (CRC) method, and the like. The detection engine may be configured as a circuit capable of acquiring a detection value according to various validity check methods.

When a write request and a first detection value are received, the NVM controller 220 may determine whether a write operation is to be performed, based on the first detection value and a second detection value.

The write request and the first detection value may be received from the processor 210. The write request may be a request for controlling the NVM 100 to perform a write operation of storing data stored in at least one selected bank among the plurality of banks Bank 1 to Bank 3 in the NVM 100. The number of the selected bank(s) may be one or a plural number. Hereinafter, for illustrative purpose, a case where the first bank Bank 1 is selected will be described.

The first detection value and the second detection value may be detection values of the same bank. That is, the first detection value and the second detection value may be acquired by the same detection engine. For example, when the first bank Bank 1 among the plurality of banks Bank 1 to Bank 3 is selected, the first detection value and the second detection value may be detection values of the first bank Bank 1.

The first detection value may be a detection value acquired at a time prior to a time at which the second detection value is acquired. That is, the second detection value may be a detection value acquire after the time at which the first detection value is acquired. In an embodiment, the first detection value acquired when data stored in the first bank Bank 1 is updated. Updating of the data means that the data is first stored or that the data is changed and stored after the data is first stored. In an embodiment, the second detection value may be a detection value acquired when a write operation of storing the data of the first bank Bank 1 is received.

In an embodiment, the NVM controller 220 may include a write operation controller 221 and an engine controller 223.

The write operation controller 221 may receive a write request and a first detection value from the processor 210.

In an embodiment, the write request may include a bank address and a block address.

The bank address may be an identifier representing one bank among the plurality of banks Bank 1 to Bank 3 included in the VM 230. For example, when data to be stored in the NVM 100 is stored in the first bank Bank 1 among the plurality of banks Bank 1 to Bank 3 of the NVM 230, the bank address may be an address representing the first bank Bank 1. That is, the bank address represents a position of a source in which the data is stored.

The block address represents a storage area of the NVM 100 in which the data is to be stored. That is, the block address represents a destination in which the data is to be stored. Meanwhile, the bank address and the block address may be included in the write request, or be implemented in a form in which the bank address and the block address exist separately from the write request.

The first detection value may be received together with the write request, or be received before the write request is received. The write operation controller 221 may transmit the bank address to the engine controller 223 in response to the write request.

The engine controller 223 may control a detection engine to acquire a detection value of a selected bank corresponding to the write request.

In an embodiment, the engine controller 223 may control the detection engine to select a specific bank among the plurality of banks Bank 1 to Bank 3, based on the bank address, and then acquire a detection value of the selected bank. For example, the engine controller 223 may select the first bank Bank 1 represented by the bank address among the plurality of banks Bank 1 to Bank 3 or the first detection engine Detection Engine 1 connected to the first bank Bank 1. The engine controller 223 may control the first detection engine Detection Engine 1, connected to the first bank Bank 1 among the plurality of detection engines Detection Engine 1 to Detection Engine 3, to acquire a detection value of the first bank Bank 1. The detection value acquired by the first detection engine Detection Engine may be a second detection value of the first bank Bank 1. In addition, the first detection engine Detection Engine 1 may transmit the second detection value to the write operation controller 221. Meanwhile, the second detection value may be directly transmitted to the write operation controller 221, or be transmitted to the write operation controller 221 via the engine controller 223.

In an embodiment, the write operation controller 221 may compare the first detection value and the second detection value with each other, thereby determining whether a write operation is to be performed. For example, when the first detection value and the second detection value are the same, the write operation controller 221 may determine that the write operation is performed. When the first detection value and the second detection value are different from each other, the write operation controller 221 may determine that the write operation is suspended.

More specifically, when the second detection value is equal to the first detection value, the write operation controller 221 may transmit, to the NVM 100, the write request for controlling the NVM 100 to perform the write operation and the data stored in the selected bank. The write operation controller 221 may transmit, to the NVM 100, a block address representing a specific storage area of the NVM 100 together with the write request and the data such that the data is stored in the specific storage area. That the second detection value of the first bank Bank 1 is equal to the first detection value of the first bank Bank 1 may mean that the data stored in the first bank Bank 1 is valid.

In an embodiment, when the second detection value is not equal to the first detection value, the write operation controller 221 may control the NVM 100 to suspend the write operation. That is, the write operation controller 221 may not transmit the write request and the data to the NVM 100. The fact that the second detection value of the first bank Bank 1 is different from the first detection value of the first bank Bank 1 may mean that the data stored in the first bank Bank 1 is damaged. Here, since storing the data stored in the first bank Bank 1 in the NVM 100 means that the damaged data is stored, the suspension of the write operation may be preferable in terms of efficiency and accurate detection of an error occurrence location.

In an embodiment, when the write operation is suspended, the write operation controller 221 may store, in the VM 230, report information representing that the write operation has been suspended, or transmit the report information to the host. The processor 210 may inhibit data storage of the first bank Bank 1 according to the report information such that the data is not stored in the first bank Bank 1. Meanwhile, the processor 210 may control VM 230 such that the data is preferentially stored in another bank other than the first bank Bank 1, among the plurality of banks Bank 1 to Bank 3 according to the report information.

In accordance with the present disclosure, the NVM controller 220 may perform a validity check on data by using the second detection value acquired before the data is stored in the NVM 100, so that the validity of data can be accurately checked and the efficiency of the validity check can be improved. The NVM controller 220 may directly control the error detection engine 240, thereby sharing a workload of the processor 210.

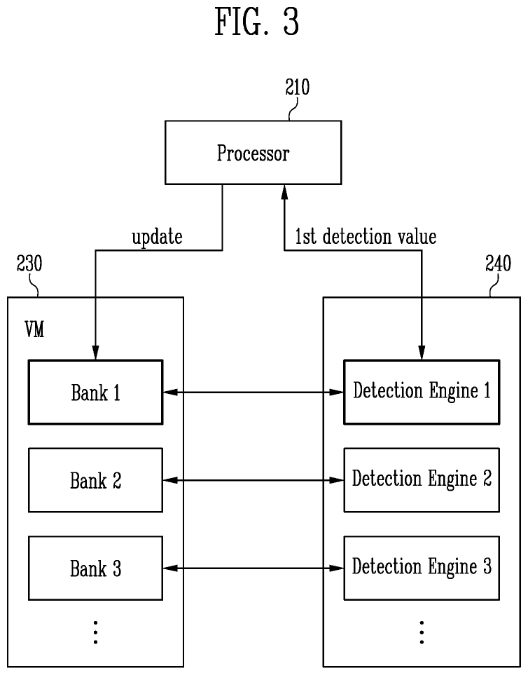

FIG. 3 is a diagram for describing an operation of the processor 210 of the storage device 1000 in accordance with an embodiment of the present disclosure.

Referring to FIG. 3, the processor 210 may update data stored in one bank among the plurality of banks Bank 1 to Bank 3 included in the VM 230. For example, when information indicating a residual lifetime of the NVM 100, as data, is stored in the first bank Bank 1 of the VM 230, the processor 210 may change a value of the data on the residual lifetime as an erase count of the NVM 100 increases or as time elapses, and store the changed value in the first bank Bank 1 of the VM 230.

In an embodiment, when data stored in a selected bank is updated, the processor 210 may control a detection engine to acquire a first detection value of the selected bank. For example, when data stored in the first bank Bank 1 is updated, the processor 210 may transmit a control signal to the first detection engine Detection Engine 1 connected to the first bank Bank 1 among the plurality of detection engines Detection Engine 1 to Detection Engine 3 included in the error detection engine 240. The first detection engine Detection Engine 1 may acquire a first detection value of the first bank Bank 1 in response to the control signal. That is, the first detection value acquired by the first detection engine Detection Engine 1 is a detection value obtained by reflecting the updated data of the first bank Bank 1. Meanwhile, descriptions of a method of acquiring a detection value overlaps with those described above, and therefore, will be omitted. Further, the first detection engine Detection Engine 1 may transmit the first detection value to the processor 210.

In an embodiment, when the data stored in the selected bank is updated, the processor 210 may not acquire any detection values of the other banks except the selected bank among the plurality of banks Bank 1 to Bank 3. That is, the processor 210 may control detection engines not to acquire any detection values of the banks of which data are not updated, so that the efficiency of a validity check can be improved.

The processor 210 may control the detection engine to acquire the first detection value of the selected bank among the plurality of banks Bank 1 to Bank 3, whenever the data stored in the selected bank is updated. In an embodiment, the processor 210 may include a cache memory. The processor 210 may store the first detection value in the cache memory. The processor 210 may acquire the first detection value of the selected bank and store the first detection value in the cache memory whenever the data stored in the selected bank is updated. Accordingly, the first detection value may be maintained as a value obtained by reflecting data which has most recently been updated in the selected bank Bank 1.

After that, when a write request for storing the data stored in the selected bank in the NVM is transmitted to the NVM controller, the processor 210 may transmit, to the NVM controller, the first detection value of the selected bank together with the write request. The first detection value is a detection value obtained by reflecting data which has most recently been updated. The descriptions illustrated in FIG. 2 may be applied to descriptions of a subsequent operation.

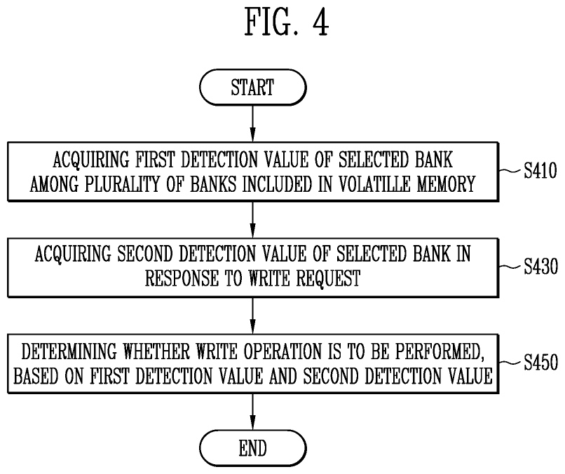

FIG. 4 is a flowchart for describing an operation of the storage device 1000 in accordance with an embodiment of the present disclosure.

Referring to FIG. 4, the operation of the storage device 1000 may include operation S410 of acquiring a first detection value of a selected bank among a plurality of banks included in the VM 230, operation S430 of acquiring a second detection value of the selected bank in response to a write request for requesting a write operation of data stored in the selected bank in the NVM 100, and operation S450 of determining whether the write operation is to be performed, based on the first detection value and the second detection value.

Each of the first detection value and the second detection value is a value acquired as a result obtained by performing a detection operation of identifying validity (or integrity) of the data stored in the selected bank among the plurality of banks. In an embodiment, each of the first detection value and the second detection value may be acquired through one of various validity check methods including a parity check method, a Cyclic Redundancy Check (CRC) method, and the like. Each of the first detection value and the second detection value may be acquired through a detection engine connected to the selected bank among a plurality of detection engines.

The data stored in the selected bank may include at least one of meta-data and user data. The user data may be data received from the host 300 or the NVM 100. The meta-data may include information associated with an operation of the NVM 100 or information associated with the user data. For example, the meta-data may include a residual lifetime of the NVM 100. Further, the meta-data may include at least one of a file name, a file attribute, a storage time, an access time, a file size, and the like of the user data.

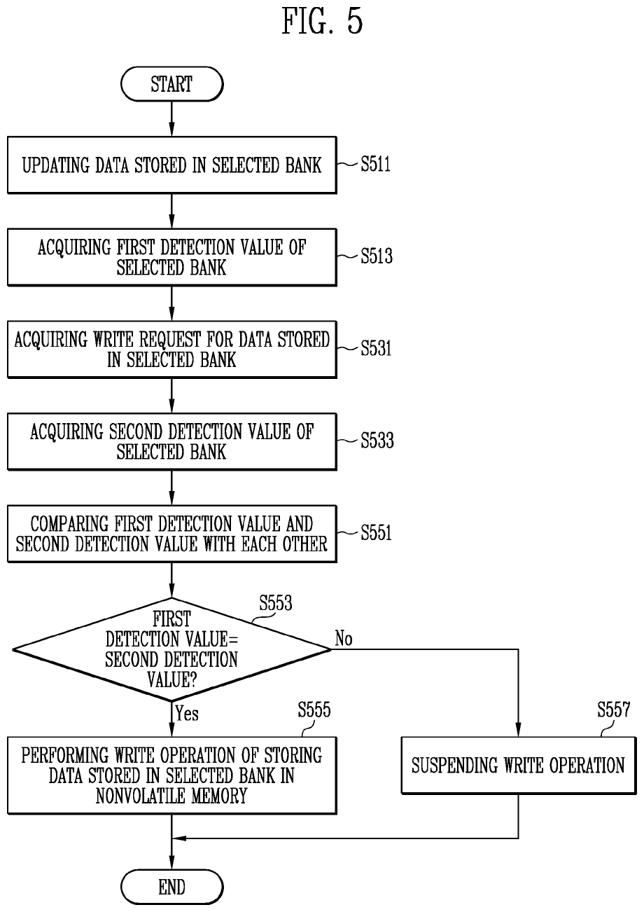

FIG. 5 is a flowchart for describing detailed operations of the storage device 1000 in accordance with an embodiment of the present disclosure.

Referring to FIG. 5, in operation S511, data stored in a selected bank among the plurality of banks included in the VM 230 may be updated. Updating of the data means that the data is first stored or that a value of the data is changed.

In operation S513, when the data stored in the selected bank among the plurality of banks is updated, a first detection value of the selected bank may be acquired. Any detection values of the other banks except the selected bank among the plurality of banks may not be acquired.

In operation S531, a write request for requesting a write operation of storing, in the NVM 100, the data stored in the selected bank among the plurality of banks may be acquired. For example, the write request may be received from an external device (e.g., the host 300) of the storage device 1000, or be generated by the processor 210 of the storage device 1000. In operation S533, a second detection value of the selected bank among the plurality of banks may be acquired.

In operation S551, the first detection value and the second detection value may be compared with each other. In an embodiment, it may be compared whether the first detection value and the second detection value are the same.

In an embodiment, when the second detection value is equal to the first detection value (Yes in operation S553), it may be determined that a write operation of storing the data stored in the selected bank in the NVM 100 is performed (operation S555). Meanwhile, when the second detection value is not equal to the first detection value (No in operation S553), it may be determined that the write operation is suspended (operation S557).

In accordance with the present disclosure, there can be provided a storage device capable of performing a validity check of data stored in a volatile memory when the data is stored in a nonvolatile memory device, and an operating method of the storage device.

In accordance with the present disclosure, performance deterioration of the storage device according to the validity check of data can be reduced.

While the present disclosure has been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations may not be performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein and the following claims. Furthermore, the embodiments may be combined to form additional embodiments.

What is claimed is:

1. A storage device comprising:
a nonvolatile memory configured to store data;
a volatile memory including a plurality of banks;
a plurality of detection engines each configured to acquire a detection value representing validity of data stored in a corresponding bank among the plurality of banks; and
a nonvolatile memory controller configured to determine, when a write request for requesting a write operation of storing data stored in a selected bank among the plurality of banks into the nonvolatile memory and a first detection value of the selected bank are received, whether the write operation is to be performed, based on the first detection value and a second detection value acquired by a detection engine corresponding to the selected bank after the write request is received.

2. The storage device of claim 1, wherein the nonvolatile memory controller includes a write operation controller configured to transmit, to the nonvolatile memory, the write request and the data stored in the selected bank when the second detection value is equal to the first detection value.

3. The storage device of claim 2, wherein the write operation controller is configured to control the nonvolatile memory to suspend the write operation when the second detection value is not equal to the first detection value.

4. The storage device of claim 1, further comprising a processor configured to control the detection engine to acquire the first detection value of the selected bank when the data stored in the selected bank is updated before the write request is received.

5. The storage device of claim 4, wherein, when the data stored in the selected bank is updated, the processor does not acquire any detection value of the other bank except the selected bank among the plurality of banks.

6. The storage device of claim 4, wherein the processor transmits to the nonvolatile memory, the write request and the first detection value acquired after the data is updated.

7. The storage device of claim 1, wherein the nonvolatile memory controller includes an engine controller configured to select, when the write request and a bank address representing the selected bank are received, the detection engine corresponding to the bank address and control the detection engine to acquire the second detection value of the selected bank.

8. The storage device of claim 1, wherein each of the first detection value and the second detection value is a value acquired by the detection engine, using a checksum method, by using a value of the data stored in the selected bank.

9. A method of operating a storage device, the method comprising:
acquiring a first detection value of a selected bank among a plurality of banks included in a volatile memory;
acquiring a second detection value of the selected bank in response to a write request for requesting a write operation of storing, in a nonvolatile memory, data stored in the selected bank; and
determining whether the write operation is to be performed, based on the first detection value and the second detection value.

10. The method of claim 9, wherein the determining of whether the write operation is to be performed includes:
determining that the write operation is performed when the second detection value is equal to the first detection value; and
determining that the write operation is suspended when the second detection value is not equal to the first detection value.

11. The method of claim 9, wherein, in the acquiring of the first detection value, the first detection value of the selected bank is acquired when the data stored in the selected bank is updated.

12. The method of claim 11, wherein, when the data stored in the selected bank is updated, any detection value of the other bank except the selected bank among the plurality of banks is not acquired.

13. A storage device comprising:
a nonvolatile memory configured to store data; and
a memory controller including a volatile memory,
wherein the memory controller is configured to:
acquire a first detection value of a selected bank among a plurality of banks included in the volatile memory;
acquire a second detection value of the selected bank in response to a write request for requesting a write operation of storing, in the nonvolatile memory, data stored in the selected bank; and
determine whether the write operation is to be performed by comparing the first detection value and the second detection value.

14. The storage device of claim 13, wherein the memory controller is configured to:
determine that the write operation is performed when the second detection value is equal to the first detection value, and
determine that the write operation is suspended when the second detection value is not equal to the first detection value.

15. The storage device of claim 13, wherein the first detection value of the selected bank is acquired when the data stored in the selected bank is updated.

16. The storage device of claim 15, wherein, when the data stored in the selected bank is updated, any detection value of the other bank except the selected bank among the plurality of banks is not acquired.
